(19) United States
(12) Patent Application Publication
(10) Pub. No.: US 2013/0275907 A1
(43) Pub. Date: Oct. 17, 2013

(54) VIRTUAL KEYBOARD

(71) Applicants: Hannes Lau, Hamburg (DE); Christian Sax, Christchurch (NZ)

(72) Inventors: Hannes Lau, Hamburg (DE); Christian Sax, Christchurch (NZ)

(73) Assignee: University of Technology ,Sydney, Ultimo (AU)

(21) Appl. No.: 13/879,325

(22) PCT Filed: Oct. 14, 2011
(86) PCT No.: PCT/AU2011/001309

§ 371 Date: Jun. 27, 2013

(30) Foreign Application Priority Data
Oct. 14, 2010 (AU) 2010904592

(51) Int. Cl. G06F 3/0488

(52) U.S. Cl. CPC G06F 3/0488
USPC 715/773

(57) ABSTRACT

A method of providing an interface comprising receiving contact information indicative of points of contact between fingers of at least one hand and a surface. The method further comprising mapping onto the surface a plurality of interface elements each corresponding to a key on a keyboard, each element being assigned to one of a plurality of groups, each group having an associated one of the fingers for activation of the elements in the group, wherein each group is mapped to the surface in accordance with contact information for the associated finger. Another aspect of the inventive include recurrently receiving the contact information and recurrently mapping each group to the surface in accordance with the contact information for the associated finger so that the group tracks the resting position of the associated finger.

### FIELD OF THE INVENTION

The present invention generally relates to a method and system for providing an interface, and particularly but not exclusively, to a method and system for providing a virtual keyboard.

### BACKGROUND OF THE INVENTION

Computing systems that have a virtual keyboard—‘soft keys’—rather than a mechanical keyboard are known. Example systems include mobile telephones such as the iPhone, and tablet computers such as the iPad. Typically, the keyboard is displayed on a touch screen and a user touches the screen to indicate that a symbol associated with that key is entered into the computing device. Virtual keyboards typically provide lesser text input performance than physical keyboards.

On an English QWERTY keyboard layout the fingers are placed on the A-S-D-F and J-K-L-; keys for the left and right hand fingers respectively—these keys are called home keys. Both thumbs rest on the space key. Proficient typists know where other keys are when resting their fingers on the home keys. They do not need to look at the keyboard while typing.

A virtual keyboard does not have a tactile guide to key position. As a consequence users have to look at the virtual keyboard to locate the key they wish to activate. A lower text input speed and a higher error rate typically results.

### SUMMARY OF INVENTION

According to a first aspect of the invention, there is provided a method of providing an interface comprising mapping onto a surface a plurality of interface elements operable by a hand, the mapping using contact information indicative of points of contact between the hand and the surface.

According to a second aspect of the invention there is provided a method of adapting an interface, the method comprising adapting the interface in accordance with a sensed hand position relative to the interface.

Embodiments of the first and second aspects are next described.

In an embodiment, the mapping of the interface elements, or adapting the interface, is performed when a pressure exerted on the surface by the hand is within a pressure range. When the exerted pressure exceeds the maximum of the pressure range an interface element may be activated. Alternatively or additionally, the mapping of the interface elements, or adapting the interface, may be performed when the separation between the sensed hand position and the surface is within a separation range. When the separation between the sensed hand position and the surface is less than the separation range an interface element may be activated.

In an embodiment, the surface may be a touch sensitive surface. The surface may be part of a touch sensitive display. The surface is not touch sensitive in all examples, however. In some examples, contact information may be determined by other means such as by acquiring images of the hand at the surface and analysis of the images.

In an embodiment, the method comprises the step of displaying the mapped interface on the surface. Alternatively, an image of the interface may be displayed on a display separate from the surface.

In an embodiment, placing 10 fingers on the surface invokes a virtual QWERTY or similar keyboard. Placing 5 fingers of the surface may invoke a virtual numeric keypad. Placing 3 fingers on the surface may invoke virtual arrow keys. Generally, any suitable keyboard may be invoked.

According to a third aspect of the invention there is provided a method of providing an interface comprising:

receiving contact information indicative of points of contact between fingers of at least one hand and a surface; and

mapping onto the surface a plurality of interface elements each corresponding to a key on a keyboard, each element being assigned to one of a plurality of groups, each group having an associated one of the fingers for activation of the elements in the group, wherein each group is mapped to the surface in accordance with contact information for the associated finger.

The keyboard may be a physical keyboard. Alternatively, in this and the other aspects of the invention the keyboard may be a model of a keyboard. The model may be stored on a computer system, such as a system having an interface apparatus providing the interface. The model of the keyboard may comprise information about a symbol associated with each key of the keyboard, and the relative position of each key. The model may comprise information grouping the elements and the associated finger.

In an embodiment, the method may map onto a touch screen a virtual keyboard adapted to the user's natural finger positions, and physical characteristics of the user such as the size of each of the user's finger. When the keyboard is displayed it may appear directly under the user's fingertips. The keyboard may follow resting finger position. Users may find and touch the keys without feeling the home or any other keys. The user may rest their fingers on the screen while typing. Consequently, a surprisingly high typing speed and accuracy may be achieved.

In an embodiment, the step of mapping comprises mapping the keyboard in accordance with the points of contact between the fingers and the surface. The step of mapping may comprise orientating the keyboard layout in accordance with the points of contact between the fingers and the surface. The step of mapping may comprise scaling the keyboard in accordance with the points of contact between the fingers and the surface. The step of mapping may comprise translating the keyboard in accordance with the points of contact between the fingers and the surface. The mapping step may comprise a geometrical transformation that maps each of the keyboard's home keys onto the surface in accordance with the points of contact between the fingers and the surface. The mapping may comprise a Helmert transformation that maps each of the keyboard's home keys onto the surface in accordance with the points of contact between the fingers and the surface.

In an embodiment, the method comprises the step of aligning each group in a direction in which each associated finger extends when extended from its resting position on the surface. The step of aligning each group may comprise determining the direction in which each respective finger extends. The step of determining the direction in which each associated finger extends may comprise determining the position of an associated wrist. The step of determining the position of the associated wrist may comprise using the contact information to construct a geometrical model of the hand using the information, and inferring the position of the associated wrist from the model. The geometrical model may comprise a triangle having one vertex at the resting position of one of the fingers, another vertex at the resting position of another finger, and the remaining vertex, where the wrist is assumed to be, is positioned according to a ratio of dimensions of the triangle. The triangle may be an isosceles triangle. The base vertices of the triangle may be located at the resting positions of the one and the another fingers. The ratio may be that of the base of the triangle to the height of the triangle. The ratio may have a value in the range of 0.4 to 0.6. The ratio may have a value of 0.47.

In an embodiment, each home key of the model keyboard is mapped to a position displaced from the resting position of the associated finger on the surface. The translation may be by less than a characteristic dimension of a finger tip. The characteristic dimension may be determined from the contact information.

In an embodiment, the keyboard may be a QWERTY keyboard. The methods described herein are generally applicable to any type of keyboard, however.

In an embodiment, the method comprises the step of recurrently receiving points of contact information and shifting each of the groups in accordance with the information so that each of the groups track the resting position of the respective finger.

In a fourth aspect of the invention there is provided a method comprising:

recurrently receiving contact information indicative of points of contact between fingers of at least one hand and a touch sensitive surface, each finger having an associated group of interface elements that can each be activated by the finger, each interface element corresponding to a key on a model keyboard, wherein each group is recurrently mapped to the surface in accordance with the contact information for the associated finger so that the group tracks the resting position of the associated finger.

In an embodiment, one of the keys in each group is a designated home key. Mapping each group may place the home key under the associated finger.

In an embodiment of any one of the aspects of the invention, each interface element is represented by a single point.

In an embodiment of any one of the aspects of the invention, the surface is part of a touch sensitive display.

In an embodiment of any one of the aspects of the invention, pressure information indicative of applied pressure associated with the points of contacts may be used to activate one of the interface elements. The pressure information may be determined from contact area information derived from the contact information.

According to a fifth aspect of the invention there is provided a method of establishing a virtual interface on a computing system, the method comprising:

receiving contact information indicative of points of contact between fingers of at least one hand of a user and a surface; and

using the contact information to determine which of a plurality of interface types the user desires to use.

In accordance with a sixth aspect, the present invention provides a computer program comprising instructions for controlling a computing system to implement a method in accordance with any one of the first to fifth aspects of the invention.

In accordance with a seventh aspect, the present invention provides a tangible computer readable medium providing a computer program in accordance with the sixth aspect of the invention.

In accordance with a eighth aspect of the present invention provides an interface apparatus with a touch sensitive surface configured to perform a method in accordance with either one of the first and second aspects.

In accordance with a ninth aspect of the invention, there is provided an interface apparatus computing system comprising:

a contact information receiver adapted to receive contact information indicative of points of contact between fingers of at least one hand and a surface; and

a mapper adapted to map onto the surface a plurality of interface elements each corresponding to a key on a keyboard, each element being assigned to one of a plurality of groups, each group having an associated one of the fingers for activation of the elements in the group, wherein each group is mapped to the surface in accordance with contact information for the associated finger.

In an embodiment, the interface apparatus comprises a contact information generator adapted to generate the contact information. The interface apparatus may comprise a screen having the surface.

In accordance with a tenth aspect of the invention there is provided an interface apparatus comprising:

a mapper adapted to map onto a surface a plurality of interface elements operable by a hand, the mapping using contact information indicative of points of contact between the hand and the surface.

In an eleventh aspect of the invention there is provided an interface apparatus comprising:

a contact information receiver adapted to recurrently receiving contact information indicative of points of contact between fingers of at least one hand and a surface, each finger having an associated group of interface elements that can be activated by the finger, each interface element corresponding to a key on a keyboard; and

a mapper adapted to recurrently map each group to the surface in accordance with the contact information for the associated finger so that the group tracks the resting position of the associated finger.

In accordance with a twelfth aspect, there is provided a data signal comprising a computer program in accordance with the sixth aspect of the invention.

Were possible, a feature of any one of the aspects of the invention may be combined with the features of any other one of the invention.

### BRIEF DESCRIPTION OF THE FIGURES

Embodiments of the invention will now be described by way of example only, with reference to the accompanying drawings in which:

FIG. 1 shows one example of a virtual keyboard;

FIG. 2 shows a flow diagram of one embodiment of a method;

FIG. 3 shows a schematic of functional components of a computing system;

FIG. 4 shows an example of a representation of an original keyboard model (left) and an example of the model after mapping (right);

FIG. 5 shows an example geometrical construction that may be used to determine an orientation of a hand;

FIG. 6 shows the positioning of a hand on a touch screen (left) and an example of a virtual keyboard that results (right);

FIG. 7 shows a schematic diagram representing key activation using a nearest neighbour search;

FIG. 8 shows a keyboard-sized touch screen that functions as a universal input device for a personal computer;

FIG. 9 shows a block diagram of one embodiment of a computer system having an interface;

FIG. 10 shows another example geometrical construction that may be used to determine the orientations of a person's hands for orientating a set of keys to be shown on a touch sensitive display;

FIG. 11 shows yet another geometric construction that may be used to determine finger orientation for orientating a set of arrow keys to be shown on a touch sensitive display;

FIG. 12 shows still yet another geometric construction that may be used to determine the orientation of a person's hand for orientating a numeric keypad to be shown on a touch sensitive display; and

FIG. 13 shows yet still another geometric construction that may be used to determine the orientation of a person's hand for orientating another example keyboard layout to be shown on a touch sensitive display.

### DETAILED DESCRIPTION OF EMBODIMENTS OF THE INVENTION

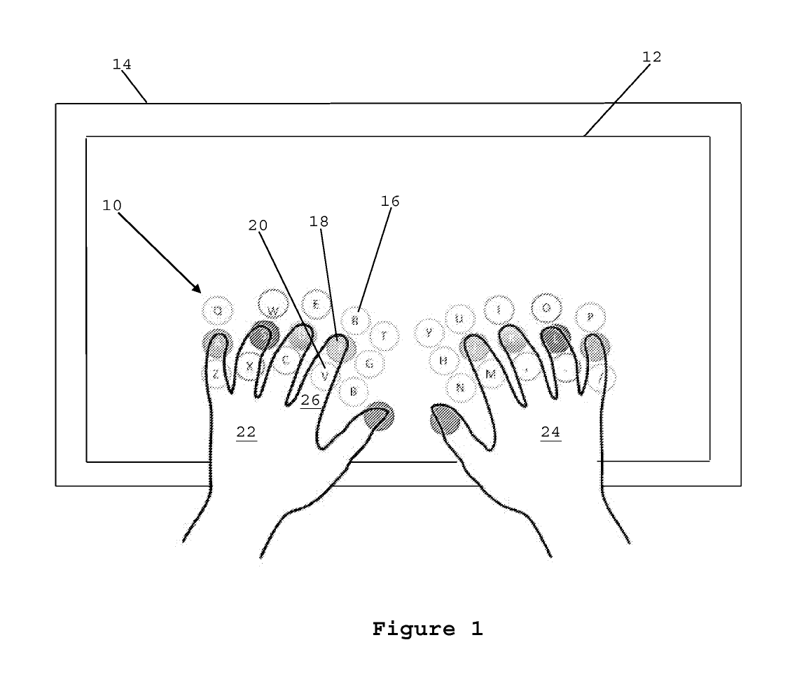

FIG. 1 shows one example of a virtual keyboard generally indicated by the numeral 10 on a touch sensitive display 12 of a computing system 14 in the form of a tablet computer, although the virtual keyboard 10 may be implemented on any suitable system with a surface adapted for a user to interface with. In the described examples, but not necessarily in all examples, the surface for touching is a touch sensitive surface that can detect pressure at points of contact between a user's hand and the surface. The virtual keyboard 10 comprises a plurality of interface elements, such as 16-20, each having an image of a key or button that is rendered on the display 12. The keyboard is adapted to be worked by hands 22 and 24 but in other examples the keyboard is adapted to be worked with only one hand. An example of a keyboard worked with only one hand is a numerical keypad. Another example of a keyboard worked with only one hand is a set of cursor keys. Touching one of the keys or buttons 16-20 with a finger such as 26 activates the touched key or button. The interface elements are arranged in a similar but not identical manner as are the keys of a model keyboard, such as a model QWERTY keyboard, stored in the computing device. Model keyboards describing DVORAK, Arabic and Asian specific layouts, and any other suitable layout, are also possible. The model keyboard comprises information about the key symbols and a preferred finger to activate each key. The model keyboard might also comprise information about the relative position of each of the keys. The plurality of interface elements are mapped onto the touch sensitive screen using point of contact information indicative of points of contact between the hand and the surface. The information is typically generated when the user places their hands 22,24 on the touch screen in preparation for typing. Once the interface elements are mapped they are rendered visible on the display.

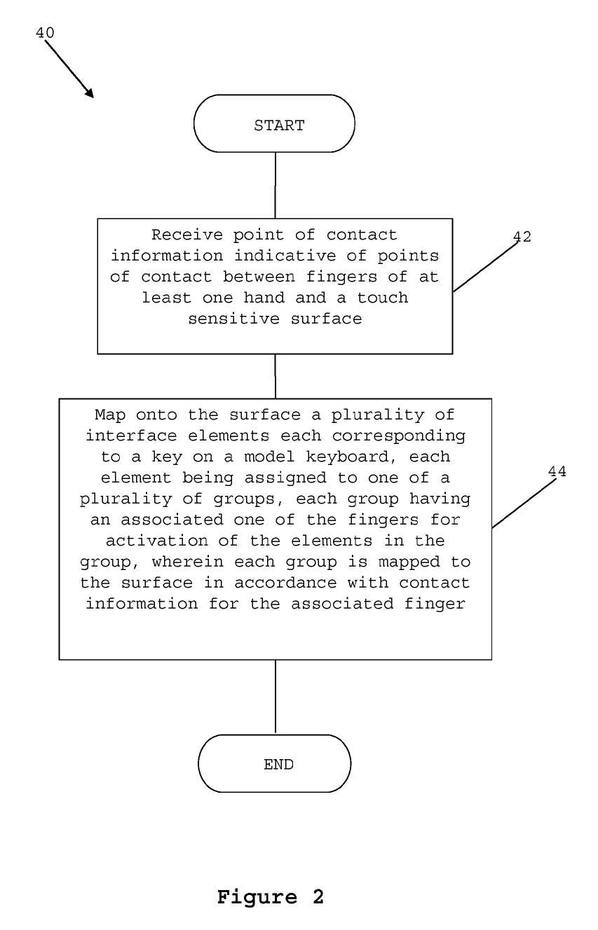

One embodiment of a method of mapping the interface elements shown in FIG. 1 is now described. FIG. 2 shows a flow diagram of the embodiment which is generally indicated by the numeral 40. Each interface element is assigned to one of a plurality of groups. For example, the keys of a QWERTY keyboard may be assigned into the groups shown in Table 1.

TABLE 1
A grouping of the left and right hand keys of a
QWERTY keyboard.

| Home key | Group | Hand |
|---|---|---|
| A | Q A Z 1 | Left hand |
| S | W S X 2 | |
| D | E D C 3 | |
| F | R T F G V B 4 5 | |
| J | Y U H J N M 6 7 | Right hand |
| K | I K , 8 | |
| L | O L . 9 | |
| ; | P ; / 0 - = | |
| SPACE | SPACE | Left & right hand |

Each group in Table 1 has an associated one of the fingers of for activation of the elements in the group. For example, the group having home key F is associated with the left index finger. FIG. 1 shows which fingers are assigned to which groups in this example.

When the user places their fingers on the display 12, the points of contact between each of the fingers and the touch screen is determined and codified as points of contact information. In this but not all examples, the contact area is reduced to a single point, the point being central of the contact area. This information is received by virtual keyboard software 42 on the system 14. Each group is mapped by the software to the surface in accordance with the point of contact for the associated finger which is determined from the point of contact information 44. In this embodiment, the home keys are placed under the associated finger. The other keys are also displayed. The home key and other keys in that group follow the associated finger position on the screen. Users are free to place their fingers anywhere and do not have to adapt to the straight key rows which most keyboards have. Consequently, the virtual keyboard is adapted to the user's natural finger positions on the surface, and other physical characteristics of the user such as the size of each of the user's finger. This may be beneficial to users with physical challenges or illnesses such as Osteoarthritis, or the elderly. The applicant believes that users using the virtual keyboard 10 will experience less hand fatigue than when using prior art virtual keyboards. This is because users can rest their fingers on the screen, instead of holding them above the screen, while typing, in addition to the keyboard being adapted to the user.

Each group follows the resting point of contact between the finger and the surface. In this but not all embodiments, the distance between the home key and the other keys in the group are held constant. The keys in the home key's group may have a constant relative position to the resting point of contact with the associated finger even as the finger changes its resting position. This may increase the speed and accuracy of typing when compared to prior art virtual keyboards. In some embodiments the distance between keys in a group are not held constant. This may be advantageous, for example, when a hand is more open (finger tips are further away from the palm) one has less finger movement range to reach keys; hence it would be better in this situation to place the keys closer together instead of keeping them at the same distance as we do at the movement.

The keyboard layout may be additionally adapted to the typing habits of a user. For example, if the user does not hit the precise centre of a key repeatedly, then the key may be shifted towards a point the user repeatedly hits. The shift may accrue over many repeated hits, as the system acquires data on the users typing. In one embodiment, a weighted mean of the actual key location and the users touch location may be used to determine the new location for the key. Alternatively, an e function over the distance between actual and expected locations may be used instead or additional to the weighted mean technique. If the user hits the backspace key after a key has been activated, the last shift of the key may be reversed and the key returned to its previous position. In this case, the system may assume that the user meant to activate a different key and that the last touch location is not where the user expects the activated key to be. The adaption may be performed either in one process step or after each touch event.

The system may use proximity and pressure data from the touch screen to, for example, differentiate between fingers that are resting on or close to the screen and fingers that press on the screen to activate a key. When it is determined that a finger is close to the screen or touches it very lightly, it is assumed that the user is not attempting to activate a key and that the user's hands are in a resting position. The points on the screen at the fingers may then be used to align the keyboard to the position, orientation and geometry of the user's hand. If, however, it is determined that the user is attempting to activate a key because of an increased proximity or pressure, a key may be activated. Generally a key will be activated only if the pressure exerted by a user's finger exceeds a certain user defined threshold. The threshold can be adapted over time according to the historical usage of the system by the user.

Some embodiments of the method are implemented using HTML, CSS, and JavaScript to create web applications that can run in Gecko and/or WebKit based web browsers. Some WebKit specific JavaScript API extensions interface with the multi-touch capability of Apple's iPhone and iPad, for example. Appendix 1 contains example Pseudo code fragments.

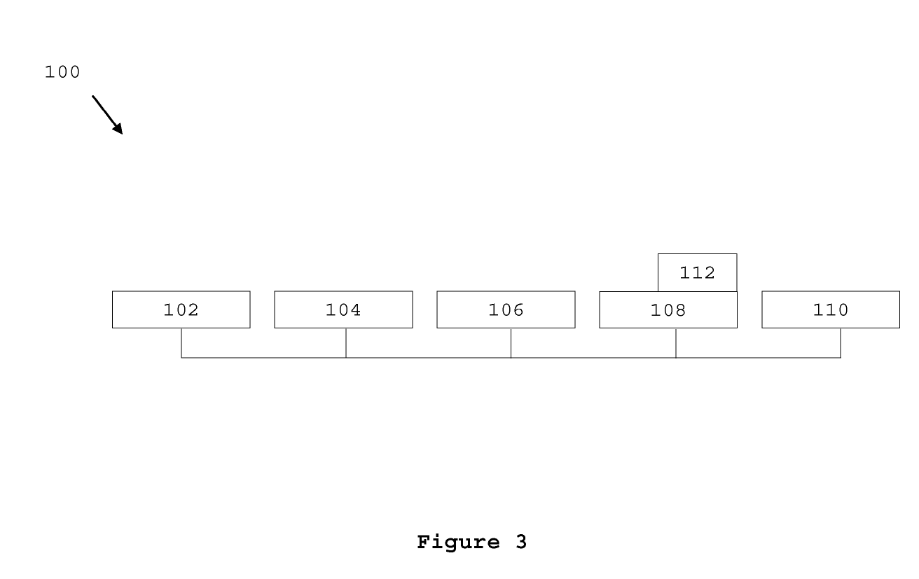

The system 14 is implemented with the aid of appropriate computer hardware and software. One example of a suitable architecture 100 is shown in FIG. 3. The computing architecture 100 comprises suitable components necessary to receive, store and execute appropriate computer instructions. The components may include a processing unit 102, volatile and non volatile memory such as read only memory (ROM) 104 and/or random access memory (RAM) 106, storage devices 108, and communication links 110 such as a wireless connection, an Ethernet port, a USB port, etc. The memory in this embodiment comprises one or more of CPU registers, on-die SRAM caches, external caches, DRAM and/or, paging systems, virtual memory or swap space on the hard drive, or any other type of memory. However, embodiments may have additional or less memory types as suitable. The computing system 100 comprises instructions that may be included in ROM 104, RAM 106 or disk drives 108 and may be executed by the processing unit 102. There may be provided a plurality of communication links 110 which may variously connect to one or more computing devices such as a server, personal computers, terminals, wireless, handheld computing devices or other devices capable of receiving and/or sending electronic information. At least one of a plurality of communications links may be connected to an external computing network through a telephone line, an Ethernet connection, or any type of communications link. Additional information may be entered into the computing system or machine by way of other suitable input devices such as, but not limited to, an optional mechanical keyboard and/or an optional mouse (not shown).

The architecture may include storage devices such as a disk drive 108 which may encompass solid state drives, hard disk drives, optical drives or magnetic tape drives. The computing system 100 may use a single disk drive or multiple disk drives. A suitable operating system 112 such as Microsoft Windows XP resides on the disk drive or in the ROM of the computing system 100 and cooperates with the hardware to provide an environment in which software applications can be executed.

In particular, the data storage system is arranged to store software including logic that controls the system 10. Typically, the logic is stored on the data storage system including tangible media (hardware) such as a hard drive, flash memory, RAM, DRAM, DVD or CD-ROM or another form of media in which the logic can be stored. The data storage system may be loaded with a module having various sub-modules (not shown). The sub-modules are arranged to interact with the architecture 100, via the operating system 112, to either receive and/or process information.

Although not required, the embodiments described herein can be implemented as an application programming interface (API) or as a series of libraries for use by a developer, or can be included within another software application, such as a terminal or personal computer operating system or a portable computing device operating system. Generally, as program modules include routines, programs, objects, components and data files which work together to perform particular functions, it will be understood that the functionality may be distributed across a number of routines, programs, objects components or data files, as required.

The architecture 100 may comprise stand alone computers, network computers, dedicated computing devices, hand held devices, or any device capable of receiving and processing information or data. Where the terms “computing system” and “computing devices” are utilized throughout the specification, these terms are intended to cover any appropriate arrangement of computer hardware and/or software required to implement at least an embodiment of the invention. For example, the computing system may be a personal computer, a mainframe-client system, may comprise thin or thick clients, an embedded system, etc.

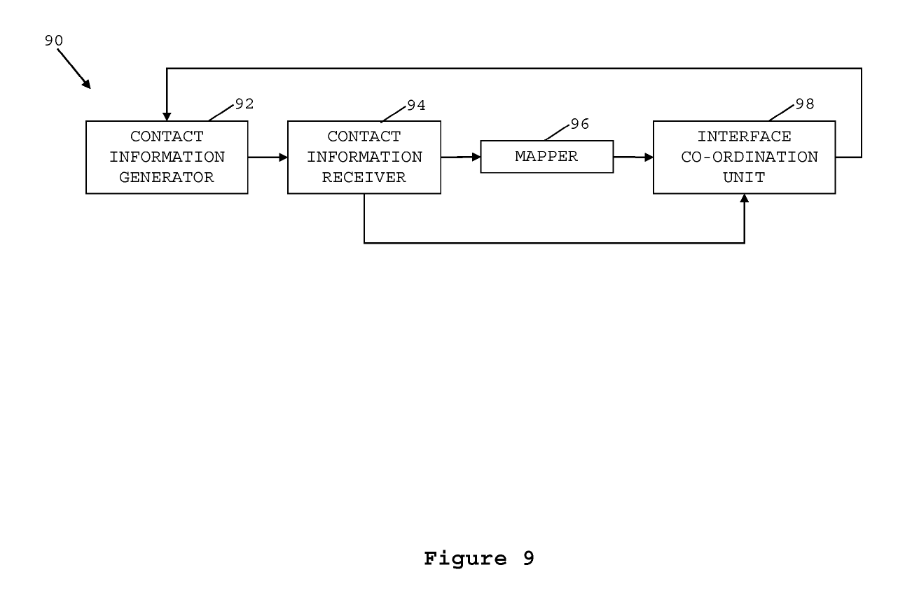

FIG. 9 shows a block diagram of one embodiment of a computer system having an interface generally indicated by the numeral 90. The system has a contact information generator 92. In this embodiment the contact information generator comprises a touch screen. The contact information generator sends the generated contact information to the contact information receiver 94. In this embodiment, the contact information receiver is a software unit running on a central processing unit 102. The contact information receiver 94 does any necessary preprocessing of the contact information generator for the mapper 96 which the contact information receiver sends the information. The mapper 96, in this embodiment, is a software unit run on the central processor 102. The mapper 96 maps the interface elements using the information as described herein and sends the mapping to an interface co-ordination unit 98. The interface co-ordination unit 98 causes a graphical image representing the interface to appear on the touch screen 92 for the users reference. The interface co-ordination unit 98 detects requests from the user to activate a particular key using the contact information received from the contact information receiver 94 and also the mapping from the mapper 96.

Examples will now be described with reference only to the right hand-side of a QWERTY keyboard, i.e. the home keys are ‘J-K-L-;’. It will be appreciated that the methods described herein may be implemented for both sides of a keyboard, as shown in FIG. 1.

The keys' positions are defined as points on the touch sensitive surface without spatial extent. After the keyboard 10 is established, each touch on the surface is algorithmically assigned to the closest key. As long as the user's finger remains on the screen an assignment may be made and the relevant key may be considered pressed. As a consequence users do not have to hit the keys exactly to activate them, which may makes the keyboard easier to use.

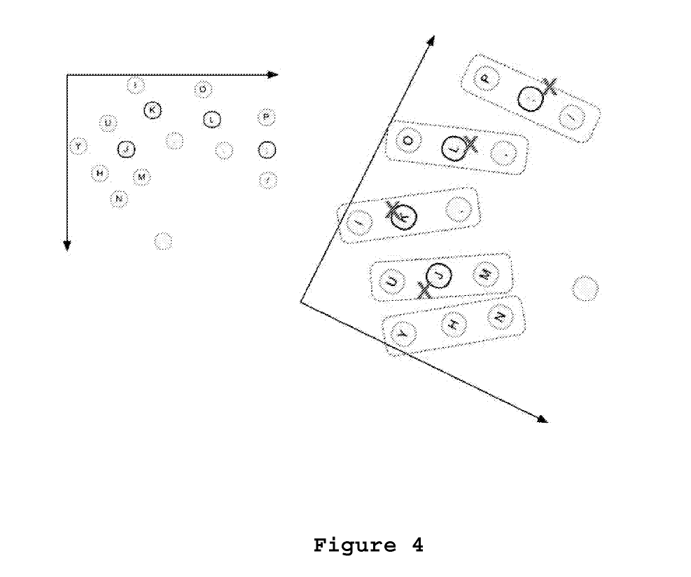

In some examples, as soon as a number of touches on the screen are sensed the touch positions are used to map the keyboard to the touch sensitive surface. In one example, a basic keyboard layout is stored in the keyboard application as a keyboard model, which specifies a position for each key including the home keys. To find an adapted keyboard layout a rotation angle, scale factor and translation vector is determined for a two dimensional transformation, which may be a Helmert transformation, of the stored layout that brings specific keys from their original positions as close as possible to the positions that the user touched. FIG. 4 shows examples of the original (left) and adapted (right) keyboard layouts in this example. In this figure, four reference points have been used to determine the transformation parameters. The user's initial touches are marked with crosses. The dashed lines depict the key groups that will be moved in unison when the user moves his fingers on the screen while the keyboard is displayed.

The equations to determine the transformation parameters might be over determined by the reference points, if more than two reference points are used. In this case, a least-square adjustment can be used to determine the transformation that provides the best match between the key positions and the users initial touch positions. The correct association of the points the user touches on the screen to the appropriate home keys is initially unknown. It is possible to consider all possible mappings and chose the one with the lowest remaining deviation.

In a second step each key group is translated, so that the respective home key is central at the touch point exactly under the user's touch, removing any remaining deviation.

One or both of these steps can be performed each time the user moves one or more fingers on the surface. The home key of each group follows the respective finger's resting position on the screen.

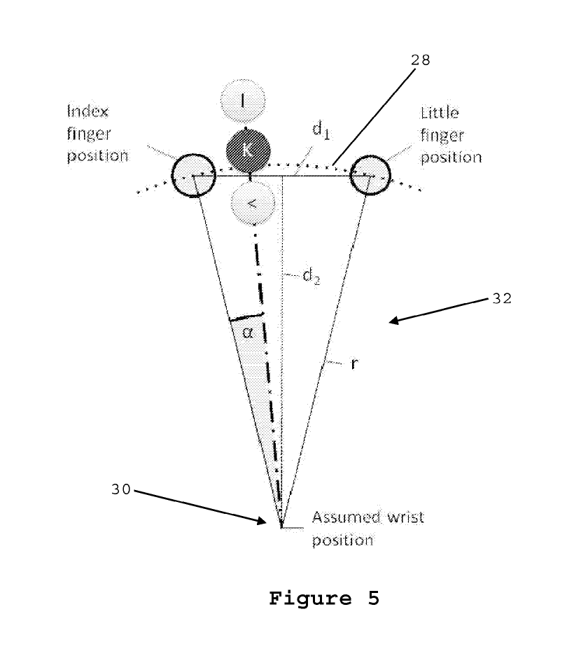

In yet another example a simpler geometric model is employed to initiate the keyboard and to adapt to changes of the fingers' resting positions relatively quickly. In this example, once five touches have been registered (including the thumb), the mapping of the home keys to the fingers' positions on the surface is determined by fitting a circle 28 to all five touch points. In this example, the fit is done using a least-squares algorithm. A portion of the circle is shown as a line of dots in FIG. 5. Going clockwise around the circle 28, the first key after the biggest angular gap is associated with the user's thumb and therefore with the space key while the second touch is mapped to the index finger and J key. All other home keys follow in a clockwise order. The circle 28 is only used to determine the mapping of the user's fingers to the home keys and discarded thereafter.

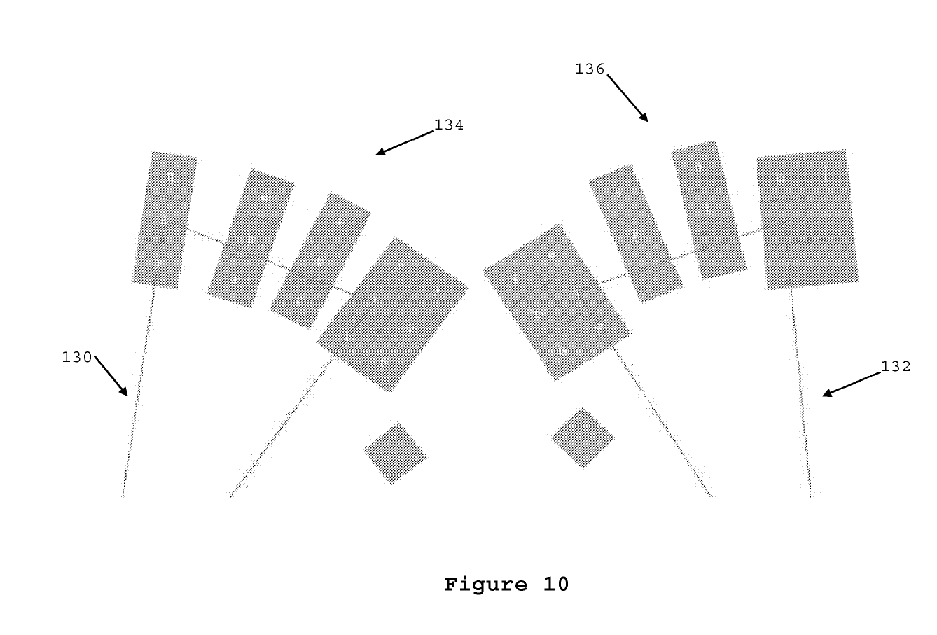

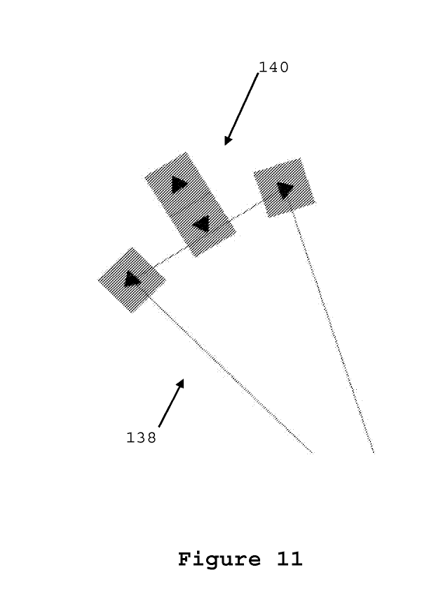

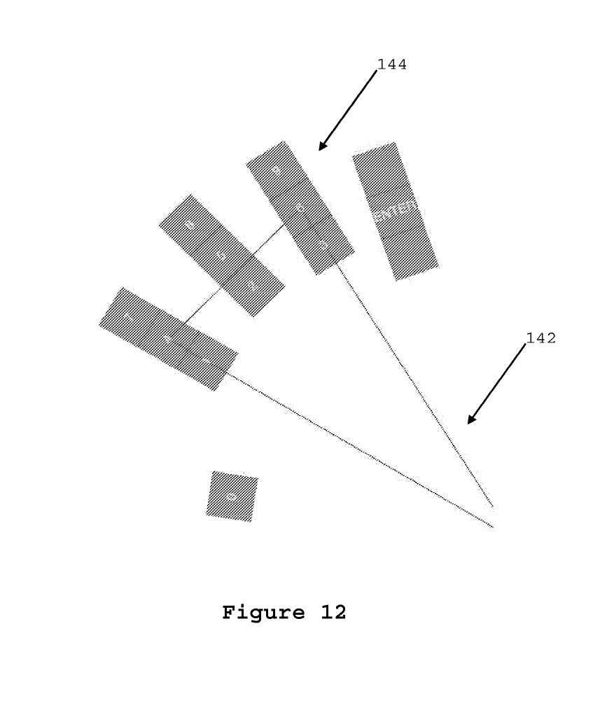

FIG. 5 shows an example geometrical construction that may be used to determine the orientation of the hand. In this example, the hand is modelled by a triangle but other geometrical models of the hand may be similarly employed. An isosceles triangle 32 is determined using the index and little fingers' contact positions as base vertices. The location of the user's wrist is assumed to be located at the apex of this triangle. The ratio of the base of the triangle to the height of the triangle is assumed to be constant and determined a priori based on the average length (finger tips to wrist=d2) and breadth (index to little finger=d1) of the human hand. In this example, the ratio d1/d2=0.47 although other values may be suitable depending on the chosen population. Generally the ratio may fall within the range of 0.4 to 0.6 but values outside of this range may be used. FIG. 10 shows other example geometrical constructions 130, 132 that may be used to determine the orientations of a person's hands. The position of the keys 134, 136 may then be determined for display purposes. FIG. 11 shows yet another geometric construction 138 that may be used to determine finger orientation for orientating a set of arrow keys 140 to be shown on a touch sensitive display. FIG. 12 shows still yet another geometric construction 142 that may be used to determine the orientation of a person's hand for orientating a numeric key pad 144 to be shown on a touch sensitive display.

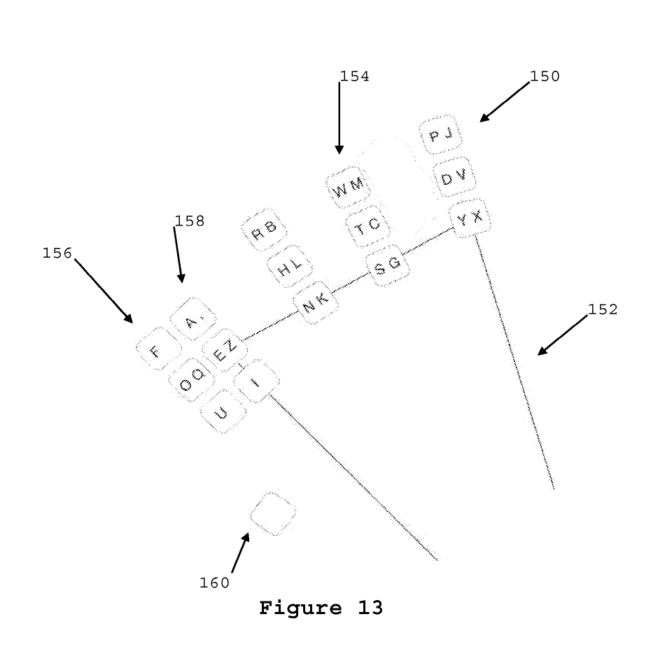

The system 14 may implement alternative virtual keyboard layouts. For example, FIG. 13 shows a alternative keyboard layout 150 bearing the letters of the alphabet which can be typed with one hand. A geometric construction 152 is shown that may be used to determine the orientation, position and geometry of the person's hand for orientating the keys 150, for example. The keys such as 154 are each associated with a plurality of letters. In the case of key 154, the letters are W and M. Key 154 may be activated, for example, by a person's right hand ring finger. Keys 156 and 158, for example, may be activated by the person's index finger. The letter entered when the person presses key 154 is determined through use of key 160. In this embodiment, pressing key 160 prior to pressing 154 toggles between the letters W and M. In an alternative embodiment, W may be the default letter when the key 160 is not pressed, and M is the active letter when key 160 is pressed. A space may be entered by double clicking 160, for example.

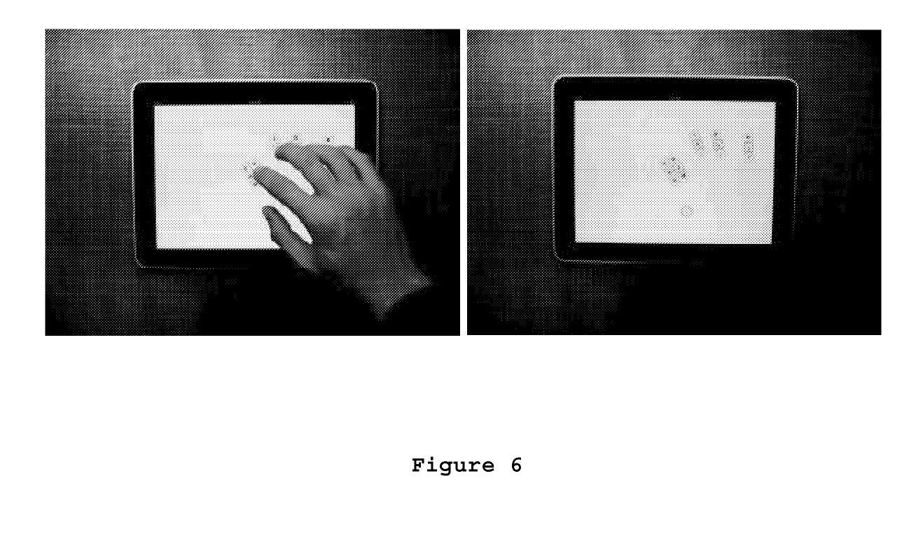

The left hand side of FIG. 6 shows the positioning of a hand on a touch screen. The right hand side of FIG. 6 shows the mapped keys (with hand removed) using the geometrical construction shown in FIG. 3. Using the geometrical construction, the wrist position and key group orientation may be updated fast enough to track the user's hand movements when implemented in many hand held devices with relatively modest computational power. Rotation of the key groups according to sensed index and little finger positions may result in a more user friendly and ergonomic keyboard layout, and may improve typing speed and accuracy.

It is possible to use geometric models of a hand that are not a triangle. Generally, the closer the model is to a real hand, the better the positioning of the keys for the user. Alternative geometrical shapes that can be used include polygons or ellipses, and generally any suitable shape can be used.

Alternatively, the touch points on the screen could be combined with detailed anatomical information to produce a three dimensional model of the hand that is touching the screen. Such a model, may comprise position of the joints and lengths of the fingers would describe best where a finger touches the screen when it is extended.

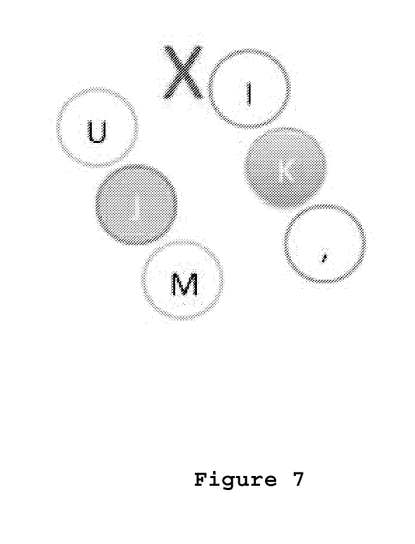

Key activation may be done by a nearest neighbour search algorithm rather than by sensing touch events within a defining geometric area (such as a rectangle or circle) representing a key 16. This approach helps with keyboard layouts such as that shown in FIG. 5, where keys are still activated if the sensed touch is close to a key but not within the defined geometric area. FIG. 7 shows a schematic diagram representing key activation using a nearest neighbour search. The ‘X’ indicates the location of the sensed finger touch, which is outside the boundary of soft-keys ‘U’ and ‘I’. By using the nearest neighbour search algorithm the ‘I’ gets activated because it is the closest key to the touch position, although the touch is not within the key boundary.

Activation of the home keys may in some circumstances be problematic. The fingers are resting on the display, which allows the algorithm to sense the touch positions and adapt the keyboard layout accordingly. The home keys will also sense touches of fingers returning to the home position after activating a key in the same key group. These touches however are not meant to activate the home keys. On a physical keyboard a finger resting on a home key can activate it by changing the applied pressure. However, most current touch screen systems are unable to determine finger pressure.

Some touch screens are capable of sensing pressure. Software may be coded for machines having such touch screens wherein increasing resting finger pressure on a home key activates it. In the case where the finger is returning to the home key position, the keyboard would sense that the pressure is not high enough to activate the key.

In the examples described above a sensed touch is recognized as two coordinates describing the position of a single point on the surface. The contact area may be reduced to a single point by taking an average of the positions of each activated point or pixel in the contact area. Alternatively, a circle, ellipse or any generally suitable geometrical object fitted to the contact area and the center designated as the single point. Any suitable algorithm may be generally employed. The information passed to the virtual keyboard software is therefore independent from the actual touch area on the touch screen, i.e. no matter how big or small the finger the result will be a single point. An indirect measure of applied finger pressure is the contact surface area between the finger and the surface. The touch area of a finger on a screen increases when the finger is pressed harder against the surface. Hence, the contact area between the touch screen and the finger is different for the finger resting and the finger actively pressing against the screen; the latter will have larger contact area. This effect can be leveraged to sense whether users are resting their fingers on the screen or are activating a home key.

On devices that are unable to sense pressure either directly or indirectly, the keyboard layout could be modified. By shifting the home keys in a forward direction relative to the users' fingertips, the user would be able to activate the home key just like any other key by moving his or her fingers to the keys position and touching it. After doing so the user could return his finger to the previous home position without unintentionally activating a key there.

Alternatively, predictive text algorithms can be used to associate the input string recognized by the keyboard. If the user typed ‘kilogram’ which comes out as “ikolgrfmj” because of a home key activation problem, the computer system 14 could map “ikolgrfmj” to the English word “kilogram”. If the mapping is ambiguous and multiple words exist whose input would be recognized as “ikolgrfmj” the input context could be used to determine the word the user intended to type.

The applicant believes that the best user experience may be achieved by sensing the touch pressure either directly or indirectly, as this more closely resembles the user's experience using a normal mechanical keyboard.

The keyboard may continually adapt to frequently missed keys. The key found to be closest to the touch point can be moved towards the touch point, improving the chance that the user will hit the key or future attempts. With this mechanism the key layout will adapt to the users' typing style.

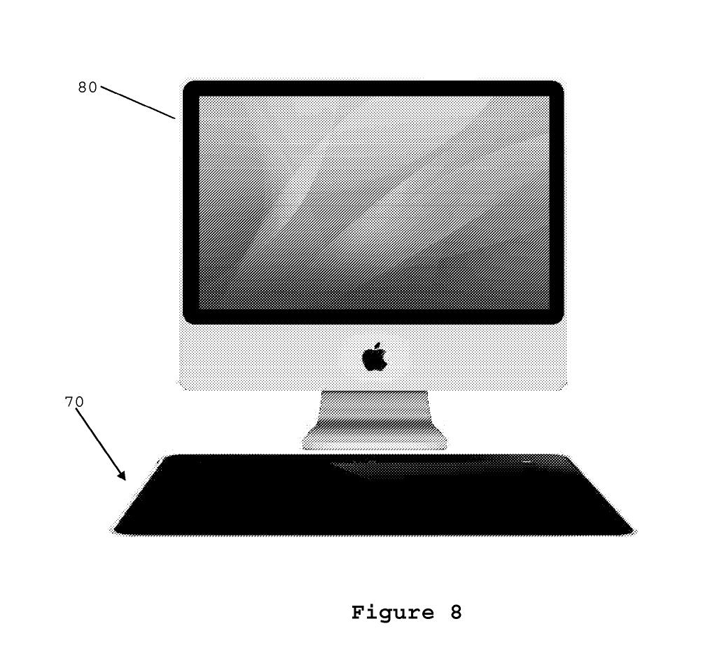

The concepts described above can be extended to surface or desktop computing scenarios. A large touch sensitive screen can be not only used for text input interface but also as a point-and-click and gesture input device. This would unite different input devices such as mouse, keyboard, and trackpad into one. FIG. 8 shows a keyboard-sized touch screen 70 that functions as a universal input device for a personal computer 80. Depending on the performed gesture different input modes are engaged. A list of suggested interactions include:
Placing 10 fingers on the surface will invoke the virtual keyboard enabling text input,
Placing 5 fingers on the surface will show a number pad only,
Swiping 4 fingers will show all available applications,
Placing 3 fingers on the surface will show the arrow keys,
2 fingers are used for scrolling,
1 finger contact is a normal point-and-click interactions such as trackpad or mouse offers.

Two hand gestures are also feasible.

An advantage is that one does not have to shift between two physical input devices such as keyboard and trackpad/mouse as often is needed with office applications. Everything can be done with one device that is flexible enough to even go beyond the gestures above, as any kind of information can be displayed on it. Hence it is also conceivable that data objects such as files are dispatched on the keyboard which can be manipulated in situ.

A combined input devices (data/text and point input) may reduce the time needed to switch between the keyboard and mouse, which is frequently found in an office application work scenario, for example when using a word processor.

Applications of the virtual keyboard examples include:
Tablet computers big enough to place one or two hands on the screen.
Touch surface interfaces such as Microsoft Surface.
Touch sensitive dual-screen laptops or tablets.
Any touch sensitive device, for instance MagicMouse from Apple, trackpads and/or mobile phones with opposing touch sensitive area. In these examples, the finger touches are sensed on a trackpad but the interface is shown on the separate display.
Desktop/kiosk systems enabled with a touch sensitive input device.
Touch and pressure sensitive interfaces.
Displays that uses haptic/tactile feedback miming ‘real’ keys on a display or touch surface.
One handed interface for a vehicle/machine control, such as a wheelchair.
Interfaces in ambient computer systems such as computers integrated in furniture, clothing or the like.
Projected displays (laser or colour/BW projector) which have an infra-red (IR) or a different finger position tracking device.
Virtual worlds and interfaces.
Data gloves.

Now that embodiments of the invention have been described in the context of examples of systems in which they are implemented, it will be appreciated that some embodiments of the invention have some of the following advantages:
a virtual keyboard is provided that is adapted to the users natural finger positions, and physical characteristics of the user such as the size of each of the user's finger;
users do not have to look at the virtual keyboard to locate the key they wish to activate, even in the absence of tactile feedback as for a mechanical keyboard;
the keys may follow the resting finger positions;
the user may rest their fingers on a surface while typing reducing fatigue;
surprisingly high typing speeds and accuracy may be achieved compared to prior art virtual keyboards;
rapid adjustment of the orientation and position of the keys can be performed, tracking resting finger position;
the virtual keyboard can be adapted to various keyboard layouts such as QWERTY, DVORAK, Arabic and Asian specific layouts, etc;
the virtual keyboard may be arranged for operation with one hand, including numeric keypads, arrow keys;
users are free to place their fingers anywhere on the surface;
users do not have to adapt to the straight key rows which most keyboards have;
the keyboard adapts to people with physical challenges or illnesses such as osteoarthritis;
users experience less hand fatigue than when using prior art virtual keyboards;
the users do not have to hit the keys exactly to activate them which may make the keyboard easier to use;
the keyboard may appear when a certain number of fingers are detected to touch the surface, such as when a hand or hands are placed in a home position as for a keyboard;
a key group is orientation is based on the hand's present position;
the orientation of a hand can be determined with relatively low computational effort;
activation of the home keys can be detected even if a touch screen is not able to measure pressure directly;
an input device that unifies a different input functions of a mouse, mechanical keyboard, etc. is provided.

It will be understood to persons skilled in the art of the invention that many modifications may be made without departing from the spirit and scope of the invention. For example, the surface may not be touch sensitive but some other means may be employed to determine contact points. For example, cameras may image the hands relative to the surface and contact information is extracted from this information. The virtual interface may be an interface for a musical instrument such as a keyboard for a piano or the like. The interface may provide special support for blind users, for example using Braille and tactile feedback via the surface. The interface may have keys which are allocated function or controls to control applications and/or manipulate digital objects such as documents. The interface may provide synchronous multi-user input on large touch sensitive areas. The interface may be specially laid out for disabled users with hand and/or finger deformation. The surface may be a surface integrated into an interface apparatus, such as a touch screen. Alternatively the surface may be, for example, a bench top supporting the apparatus, and the surface is interrogated by a machine vision system to determine the contact information. The surface may be a glass sheet, being part of a bench top for example, and the machine vision system may comprise a camera looking up through the glass at the surface. Alternatively, the various interface elements may be holographically projected into space onto a surface that is a virtual surface. In such an environment, elements can be placed at the distance, dimension, and magnification in accordance with the contact information. A machine vision system may interrogate the virtual surface.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

APPENDIX 1
Pseudo code fragments.

| Pseudo code elements | |
|---|---|
| START | Defined start of algorithm |
| END | Defined end of algorithm |
| abc; | Statement |
| // | Single line comment |
| /* | Start of block comment |
| */ | End of block comment |
| AND, OR, NOT | Boolean operators |
| <,> | smaller than, great than |
| IF condition: | Start of condition block |
| ELSE | Start of alternative block |
| ENDELSE | End of alternative block |
| ELSEIF condition: | Start of alternative condition block |
| ENDELSEIF | End of alternative condition block |
| ENDIF | End of condition block |
| WHILE condition: | Condition loop |
| ENDWHILE | Loop end |
| FOR x TIMES: | Loop executes body for x times |
| ENDFOR | Loop end |
| FOR EACH x: | Loop executes body for each time x exists |
| ENDFOR | Loop end |
| JUMP POSITION xyz; | Defines jump position named xyz |
| JUMP TO xyz; | Jumps to position xyz; |

/* The following pseudo code fragments may be used in establishing an embodiment of a virtual
keyboard.
*/
START
//initial keyboard setup
WHILE < 10 finger touches:

Sense finger touches;
Provide visual hint to place fingers on touchscreen;
IF new touch event sensed:

Provide visual, haptic and/or auditory feedback;

ENDIF
/*The following block is needed to identify the individual pressure for each touch point to tell
a normal touch from a keystroke of the homekeys apart.
*/
FOR EACH sensed touch point:

Get pressure reading;
Update running average pressure threshold;

ENDFOR

ENDWHILE
/* The following block is needed to identify the individual pressure for each touch point to tell a
normal touch from a keystroke of the homekeys apart.
*/
WHILE keyboard active:

FOR EACH sensed touch point:

Get pressure reading;
Update running average pressure threshold;

ENDFOR

ENDWHILE
//Identification of left and right hand touches on screen
Identify clusters of 5 touches;
Create cluster groups with identified touch points;
//Drawing left and right keyboard
FOR EACH cluster group:

Identify the touch points in the cluster;
/*
* Determine which touch point is associated to which finger
*/
Fit a circle outline through the the touch points that approximates
them as closely as possible in a least-square sense;
Determine angular gaps between the touch points on the circle outline
Create a sequence of the touch points in clockwise order, starting with the
touch point after the greatest angular gap.
IF working on the right hand cluster

Associate the first touch point of the sequence to the thumb
Associate the second touch point of the sequence to the index finger
Associate the third touch point of the sequence to the middle finger
Associate the fourth touch point of the sequence to the ring finger
Associate the last touch point of the sequence to the little finger

ELSE

/* working on left hand cluster */
Associate the first touch point of the sequence to the little
Associate the second touch point of the sequence to the ring finger
Associate the third touch point of the sequence to the middle finger
Associate the fourth touch point of the sequence to the index finger
Associate the last touch point of the sequence to the thumb

ENDIF
/*
* Draw a keyboard that is adapted to the users' fingers' positions
*/
Estimate wrist position based on the determined finger positions;
/*
* Each home key is sourrounded by a number of keys that are operated
* by the same finger. The home key together with these sourrounding keys
* forms a key group. There is a key group for each home key.
*/
FOR EACH key group

Place group, so that its home key is placed at the position
of the associated finger;
Rotate group, so that its virtual axis intersects with the
estimated wrist position
Draw group on the screen

END FOR

ENDFOR
// Adjusting keyboard layout according to sensed finger positions
WHILE fingers move on the screen

IF little finger OR index finger moves:

Get new little and index finger position;
Calculate new wrist position based on equation for relevant hand;

ENDIF
FOR EACH key group

Place group, so that its home key is placed at the position
of the associated finger;
Rotate group, so that its virtual axis intersects with the
estimated wrist position of the relevant hand;
Draw group on the screen;

END FOR

ENDWHILE
//Key activation detection
WHILE keyboard active:

FOR EACH cluster group:

IF new touch event sensed:

Find nearest neighbour key to touch coordinates;
//Activation of normal keys
IF nearest neighbour is NOT one of homekeys:

Return activated key;
//a key is activated
Provide visual, tactile and auditory feedback;
/*Adjust visual key position based on frequenlty
hit areas
*/
Record sensed touch position;
Move nearest neighour key partways towards touch position;

//Activation of homekeys
ELSEIF nearest neighbour IS homekey:

Get pressure of touch;
//Key activation of homekeys
IF touch pressure > key activation threshold:

Return activated homekey;
//Key is activated
Provide visual, tactile and auditory feedback;

ENDIF
Move the group that is associated to the touched
home key, in a manner that the home key is displayed
at the coordinates of the touch;
Rotate group, so that its virtual axis intersects with the
estimated wrist position of the relevant hand;
Redraw homekey group;

ENDELSEIF

ENDIF

ENDFOR

ENDWHILE
END

1-39. (canceled)

40. A method of providing an interface comprising:
receiving contact information indicative of points of contact between fingers of at least one hand and a surface; and
mapping onto the surface a plurality of interface elements each corresponding to a key on a keyboard, each element being assigned to one of a plurality of groups, each group having an associated one of the fingers for activation of the elements in the group, wherein each group is mapped to the surface in accordance with contact information for the associated finger.

41. The method of claim 40 wherein the step of mapping comprises orientating the keyboard layout in accordance with the points of contact between the fingers and the surface.

42. The method of claim 40 wherein the step of mapping comprises scaling the keyboard layout in accordance with the points of contact between the fingers and the surface.

43. The method of claim 40 wherein the step of mapping comprises translating the model keyboard in accordance with the points of contact between the fingers and the surface

44. The method of claim 40 wherein the mapping comprises a geometric transformation that maps each of the keyboard's home keys onto the surface in accordance with the points of contact between the fingers and the surface.

45. The method of claim 40 comprising the step of aligning each group in a direction in which each associated finger extends when extended from its resting position on the surface.

46. The method of claim 45 comprising constructing a geometrical model of the hand using the contact information, and inferring the position of an associated wrist from the model.

47. The method of claim 46 wherein the geometrical model comprises a triangle having one vertex at the resting position of one of the fingers, another vertex at the resting position of another finger, and the remaining vertex, where the wrist is assumed to be, is positioned according to a ratio of dimensions of the triangle.

48. The method of claim 40 wherein each home key of the model keyboard is mapped to a position displaced from the resting position of the associated finger on the surface.

49. The method of claim 40 comprising the step of recurrently receiving points of contact information and shifting each of the groups in accordance with the information so that each of the groups track the resting position of the respective finger.

50. A method comprising:
recurrently receiving contact information indicative of points of contact between fingers of at least one hand and a surface, each finger having an associated group of interface elements that can each be activated by the finger, each interface element corresponding to a key on a keyboard, wherein each group is recurrently mapped to the surface in accordance with the contact information for the associated finger so that the group tracks the resting position of the associated finger.

51. The method of claim 50 wherein one of the keys in each group is a designated home key and mapping each group places the home key under the associated finger.

52. The method of claim 50 comprising using pressure information indicative of applied pressure associated with the points of contacts to activate one of the interface elements.

53. The method of claim 52 wherein the pressure information is determined from contact area information derived from the contact information.

54. An interface apparatus comprising:
a contact information receiver adapted to receive contact information indicative of points of contact between fingers of at least one hand and a surface; and
a mapper adapted to map onto the surface a plurality of interface elements each corresponding to a key on a keyboard, each element being assigned to one of a plurality of groups, each group having an associated one of the fingers for activation of the elements in the group, wherein each group is mapped to the surface in accordance with contact information for the associated finger.

55. The interface apparatus of claim 54 further comprising a contact information generator adapted to generate the contact information.

56. The interface apparatus of claim 55 wherein the mapper is adapted to recurrently map each group to the surface in accordance with the contact information for the associated finger so that the group tracks the resting position of the associated finger.

57. A non-transient computer readable medium with instructions that cause a computing device to execute the method of claim 40.

58. A non-transient computer readable medium with instructions that cause a computing device to execute the method of claim 50.
